(19) United States
(12) Patent Application Publication
(10) Pub. No.: US 2018/0343416 A1
(43) Pub. Date: Nov. 29, 2018

(54) VIDEO PROCESSING SYSTEM AND VIDEO PROCESSING METHOD USING THE SAME

(71) Applicant: N3N Corporation, Seoul (KR)

(72) Inventor: Sung Yung Kim, Seoul (KR)

(21) Appl. No.: 15/605,593

(22) Filed: May 25, 2017

(51) Int. Cl. H04N 7/01; H04N 7/18; H04N 5/445

(52) U.S. Cl. CPC H04N 7/0117; H04N 7/181; H04N 2005/44517; H04N 5/44504; H04N 5/44513

(57) ABSTRACT

The present invention relates to a video processing system which can construct a smooth network environment by lessening a burden of a server and a video processing method using the same. To this end, the present invention provides a video processing system including: a video processing server receiving video data from a plurality of camera units and changing a resolution of the video data and transmitting the video data with the changed resolution; and a display apparatus configuring a screen based on the received video data received from the video processing server, receiving a screen conversion input from a user and requesting a change in resolution of the video data of a specific camera unit to the video processing server based on the screen conversion input.

### TECHNICAL FIELD

The present invention relates to a video processing system and a video processing method using the same, and particularly, to a video processing system which can transfer video effectively in a limited network environment by lessening a burden of a server.

### BACKGROUND ART

With the increase in propagation of surveillance cameras for reasons including determining a traffic situation, securing an evidence of a crime, and the like, demands for high-resolution cameras have also increased.

In a control room that needs to simultaneously numerous surveillance cameras, screens transmitted from a plurality of surveillance cameras are simultaneously displayed in real time and a large network load is applied in transmitting a plurality of video data in real time by using the high-resolution camera, and as a result, there are a lot of cases that the screen is cut off or server and client are strained.

According to The Apparatus and Method of Traffic Information with Navigation Terminal disclosed in Korean Patent Unexampled Publication No. 10-2011-0082870, the apparatus includes a surveillance camera photographing a vehicle which is driven on a road, a middleware server transmitting a video of the surveillance camera and traffic volume information, and a traffic control server transmitting the vide of the surveillance camera, the traffic volume information, and the like to a navigation device.

In this case, when the resolution of the respective surveillance cameras installed all over the road is 1920×1080 which is a FullHD size, a bandwidth transmitted from each surveillance camera to the middleware server is 4 Mbps, and 10 surveillance cameras are installed, the bandwidths transmitted from the surveillance cameras to the middleware server is a total of 40 Mbps. That is, video data of the respective surveillance cameras are collected in the middleware server and transmitted to the traffic control server and the bandwidths of the collected video data become 40 Mbps. As each surveillance camera has a higher resolution, a data size which needs to be processed by the middleware server significantly increases and the network load is generated.

Further, in the control room, the screens transmitted from the respective cameras are dividedly displayed and since the position of the camera cannot be intuitively known, screen configurations are limited to several configurations provided by a system, and as a result, it is difficult to arbitrarily configure the screen as a user desires.

### SUMMARY OF THE INVENTION

The present invention has been made in an effort to facilitate real-time video transmission by reducing loads of a video transmitting server and a network in a real-time video transmitting system using a plurality of high-resolution camera units in detail.

The present invention has also been made in an effort to easily configure a screen as a user desires in a control room and automatically display a screen according to an intention of the user.

An exemplary embodiment of the present invention provides a video processing system including: a video processing server receiving video data from a plurality of camera units and changing a resolution of the video data and transmitting the video data with the changed resolution; and a display apparatus configuring a screen based on the received video data received from the video processing server, receiving a screen conversion input from a user and requesting a change in resolution of the video data of a specific camera unit to the video processing server based on the screen conversion input.

The video processing server may store positional information of each camera unit and transmit the positional information to the display apparatus together with the video data, and the display apparatus may store map information, and receive the positional information of the camera unit from the video processing server and display the received video data at a corresponding camera position on a map.

The display apparatus may display the center of the screen of the corresponding camera unit to be positioned at the camera position and when a screen size is changed in one direction by a user, the display apparatus may also similarly change the screen size in another direction based on the center, and calculate a resolution which is in proportion to the changed screen size and transmit the calculated resolution to the video processing server.

The display apparatus may display map and received video data in a monitor and when the map is changed by the user, the display apparatus may detect a range of an electronic map displayed in the map and compare the range of the electronic map displayed in the monitor and the positional information of the plurality of camera units to detect the camera unit within the range of the electronic map displayed in the monitor, and the video processing server may encode the video data of the detected camera unit and transmit the encoded video data to the display apparatus again.

The display apparatus may include a clipping module, and when a clipping zone is set in the screen of the specific camera unit by the user, the clipping module may calculate a clipping position in the screen of the camera unit and transmit the calculated clipping position and the resolution of the clipping zone to the video processing server, and the video processing server may convert clipping data corresponding to the clipping position from the video data of the camera unit into the resolution received from the display apparatus and transmit the resolution to the display apparatus.

Another exemplary embodiment of the present invention provides a video processing method including: receiving, by a video processing unit, video data from a plurality of camera units; encoding, by the video processing unit, the video data and transmitting the encoded video data to a display apparatus; displaying, by the display apparatus, the received video data received from the video processing unit; calculating, by the display apparatus, a corresponding changed resolution and transmitting the calculated the changed resolution to the video processing unit when sensing that a screen size of the received vide data is changed by a user; and changing, by the video processing unit, the resolution of the video data to the changed resolution and encoding the video data with the changed resolution and thereafter, transmitting the encoded video data to the display apparatus.

According to exemplary embodiments of the present invention, a high-resolution video can be transmitted without straining a network in real time in spite of not adding a new facility.

Further, a screen desired by a user is customized to be arbitrarily displayed.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a configuration diagram illustrating the configuration of a video processing system according to the present invention;

FIG. 2 is a configuration diagram illustrating the configuration of an image processing server in FIG. 1;

FIG. 3 is a configuration diagram illustrating the configuration of a display apparatus in FIG. 1;

FIG. 4 is an exemplary diagram illustrating a monitor screen by the display apparatus;

FIGS. 5 and 6 are exemplary diagrams illustrating a change in screen by the display apparatus;

FIGS. 7 and 8 are explanatory diagrams illustrating a clipping processing process by a clipping module; and

FIG. 9 is an exemplary diagram illustrating a clipping screen by the clipping module.

### DETAILED DESCRIPTION

Configurations and actions of exemplary embodiments of the present invention will be described in detail with reference to the accompanying drawings.

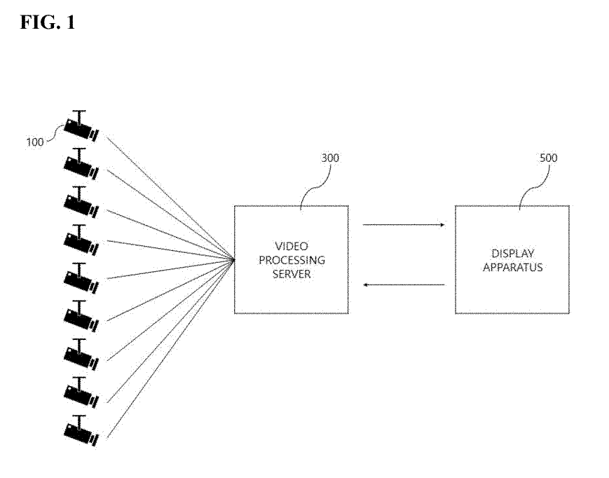

Referring to FIG. 1, a video processing system according to the present invention is configured to include a plurality of camera units 100, a video processing server 300, and a display apparatus 500.

The camera units 100 may be an IP camera, a CCTV camera, and the like and are preferably provided as a camera unit which may transmit a video of FullHD resolution (1920×1080). The camera units 100 may be installed all over buildings or roads and include a GPS terminal to transmit positional information.

The camera units 100 transmit the photographed video data to the video processing server 300 through wired or wireless communication networks including LAN and WLAN. In this case, the camera units 100 may compress and transmit the video data in a standard such as MPEG-4, H.264, or VC-1 and the camera unit may include a video stream server for transmitting the video data.

The video processing server 300 serves to receive the video data transmitted from the plurality of camera units 100 and changes the resolution of the received video data to a resolution requested in a display apparatus to be described below and transmits the video data the requested resolution to the display apparatus.

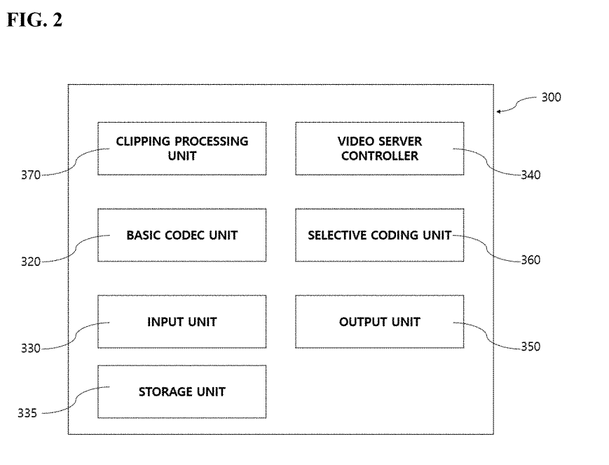

FIG. 2 is a diagram illustrating a detailed configuration of the image processing server 300. Referring to FIG. 2, the video processing server 300 is configured to include a basic codec unit 320, an input unit 330, a video server controller 340, an output unit 350, a selective coding unit 360, and a clipping processing unit 370.

The video data transmitted by the camera unit 100 is input into the video processing server through the input unit 300 and the input unit serves as an interface with an external apparatus.

The video data input into the video processing server through the input unit 330 may be transmitted to the display apparatus 500 through the output unit 350 and the video data is encoded with a basic resolution in the basic codec unit 320 when needed. The basic resolution may be predetermined and set to a resolution lower than a maximum resolution of the camera unit. For example, the basic resolution may be set to a resolution of 640×360. In this case, when needed, the video data may be decoded thereafter, encode the decoded video data with an appropriate resolution again in the basic codec unit 320. In this case, the video data may be compressed and transmitted in the standard such as MPEG-4, H.264, or VC-1.

Meanwhile, positional information (GPS information) of each camera unit 100 is stored in a storage unit 335. In this case, unique identification information of each camera unit 100 may be together stored in the storage unit. The positional information of the camera unit 100 may be manually input and the GPS information transmitted in the camera unit 100 may be automatically stored.

The video data of each camera unit, which is encoded by the basic codec unit 320 is transmitted to the display apparatus 500 through the output unit 350. The output unit 350 serves as the interface that transmits the video data to the external apparatus.

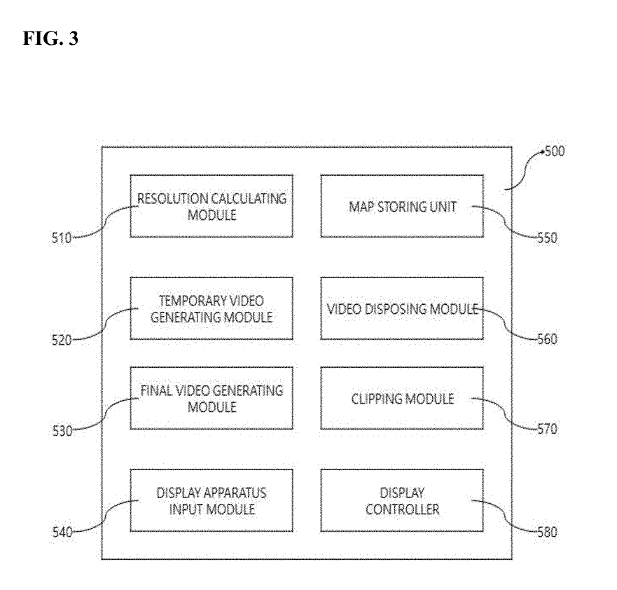

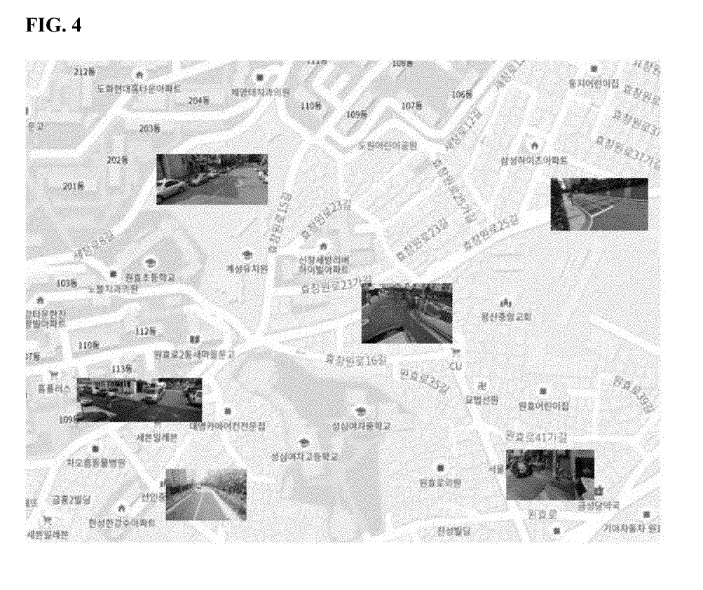

FIG. 3 is a diagram illustrating a detailed configuration of the display apparatus 500 and referring to FIG. 3, the display apparatus 500 includes a resolution calculating module 510, a temporary video generating module 520, a final video generating module 530, a display apparatus input module 540, a map storing unit 550, a video disposing module 560, a clipping module 570, and a display controller 580.

The display apparatus 500 may include a client such as a PC, Mobile device and a monitor and map information of the roads or the buildings may be stored in the map storing unit 550 and an indoor map may also be stored in the map storing unit 550.

The display controller 580 displays an electronic map on the screen such as the monitor, or the like by using the map information stored in the map storing unit 550.

Meanwhile, the display apparatus receives the video data and the positional information of each camera unit through the display apparatus input module 540 and decodes the received video data and displays the decoded video data in the monitor through the final video generating module 530. In this case, the display controller 580 configures the screen by using the received positional information.

In detail, the display controller 580 matches the video data with the electronic map by using the received positional information of each camera unit and displays the received video data at a matching location. In this case, the display controller 580 calculates the center of each screen based on the resolution and the size of each screen and disposes the center of the screen to coincide with the position of the camera unit.

The display apparatus 500 receives a screen conversion input from the user and transmits a resolution change signal to request a change in resolution of the video data of a specific camera unit to the video processing server 300 based on the screen conversion input.

The screen conversion input means the change in the position and the size, the change in arrangement method, etc. of each screen displayed in the display apparatus 500. The screen conversion input may be input by using an input device such as a mouse or a stylus pen and when the monitor is a touch screen, the screen conversion input may be input through a touch input.

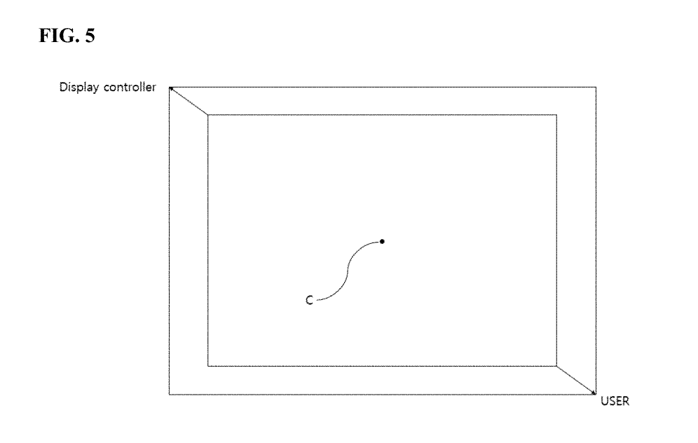

Referring to FIG. 5, in the exemplary embodiment, the center C of the screen is determined by the positional information of the camera unit and when the user changes the size of the screen in a lower right direction, the display controller 580 similarly changes the size of the screen in an upper left direction opposite to the center C of the screen as the center.

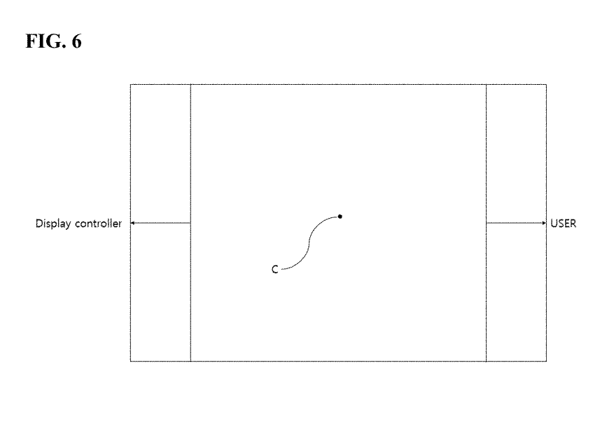

Further, referring to FIG. 6, when the user changes the size of the screen in a right direction, the display controller 580 similarly changes the size of the screen in a left direction opposite to the center C of the screen as the center.

In addition, the display controller 580 calculates the changed resolution corresponding to the changed size of the screen and compares the calculated changed resolution with an output resolution before the resolution is changed. According to a comparison result, when the changed resolution is lower than the output resolution, the changed resolution is displayed on the screen as a new output resolution and when the changed resolution is higher than the output resolution, a temporary video signal is transmitted to the temporary video generating module 520 to temporarily display the screen with the existing output resolution in the changed screen size. That is, as the screen configured by the temporary video generating module 520, a screen in which the resolution deteriorates as compared with the size of the screen is temporarily displayed.

In the exemplary embodiment, the changed resolution is calculated to be in proportion to the size of the screen and for example, when the size of the screen increases to two times, the changed resolution is calculated to be two times higher than the output resolution and when the size of the screen decreases to ⅓, the changed resolution is calculated to be ⅓ lower than the output resolution.

Meanwhile, the display controller 580 transmits a unique identification number and a changed resolution request signal of the corresponding camera unit to the video processing server 300. The unique identification number may become information to identify the camera unit, such as the positional information of the camera unit, or the like.

When the video processing server 300 receives the changed resolution request signal, the image processing server 300 changes the resolution of the video data of the corresponding camera unit to the changed resolution and encodes the video data with the changed resolution. In addition, the video processing server 300 transmits the encoded video data to the display apparatus 500 again.

Then, the final video generating module 530 displays the screen temporarily displayed by the temporary video generating module with the changed resolution by using received video data newly transmitted with the changed resolution in the video processing server 300.

As such, according to the exemplary embodiment, since the video processing server transmits only video data having a size particularly required for configuring the screen of the display apparatus 500, a network load is significantly reduced and since a time displayed by the temporary video generating module is a time as short as a person is not able to feel, the user may not almost feel cut-off of the screen in spite of changing the size of the screen.

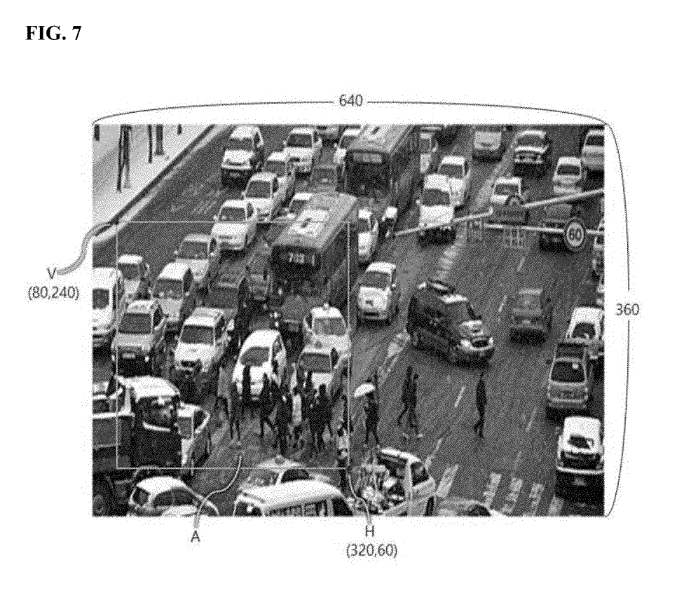

Next, the clipping module 570 will be described with reference to FIG. 7. When a clipping zone is set in the received video data screen by the user, the clipping module 570 calculates a clipping position and calculates the changed resolution of the clipping zone by using the clipping position.

In FIG. 7, zone ‘A’ may correspond to the clipping zone, the clipping zone may be set by using the input device such as the mouse or the stylus pen and when the clipping zone is the touch screen, the clipping zone may be set by the touch input.

The clipping position may be calculated by various methods, but in the exemplary embodiment, two apexes on a diagonal line of the clipping zone may be calculated as the clipping positions. That is, an upper left (V) apex and a lower right (H) apex of the clipping zone may be calculated as the clipping positions. The clipping positions may be calculated in a pixel coordinate format in a whole screen. For example, the clipping positions may be calculated as V(80,240), H(320,60), and the like.

When the clipping positions are calculated, the clipping module 570 calculates the changed resolution by using the clipping positions. That is, in the example, the changed resolution may be calculated as 320−80×240−60=240×180. In addition, the display apparatus 500 transmits the unique identification information, the clipping position, and the changed resolution of the corresponding camera unit to the video processing server 300.

Then, the clipping processing unit 370 of the video processing server 300 extracts clipping data by using the output resolution and the clipping position of the corresponding camera unit.

In detail, the clipping processing unit 370 uses the output resolution and the clipping position to calculate a ratio of the output resolution and the clipping position. That is, in FIG. 7, since the output resolution is 640×360, the ratio of a horizontal position 80 of V and a horizontal output resolution 640 is calculated as ⅛. Similarly, the ratio of the horizontal position 320 and the horizontal output resolution of H is calculated as ½.

Similarly, the ratio of a vertical position 240 and a vertical output resolution 360 of V is calculated as ⅔ and the vertical position 60 and the vertical output resolution 360 of H is calculated as ⅙.

Next, the clipping processing unit 370 calculates a position to extract the clipping data by using the calculated ratios and a resolution 1920×1080 transmitted by the camera unit 100.

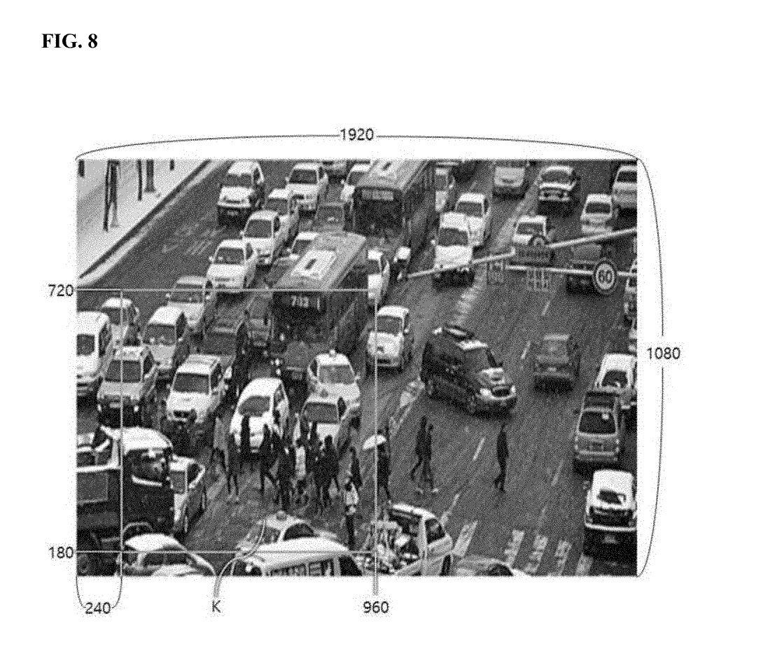

That is, referring to FIG. 8, horizontal coordinates 1920×⅛=240 and 1920×½=960 are calculated and vertical coordinates 1080×⅔=720 and 1080×⅙=180 are calculated. By such a configuration, a clipping data extraction zone K may be set.

The clipping processing unit 370 generates the clipping data by extracting pixel data in the clipping data extraction zone and the selective coding unit 360 encodes the clipping data according to the changed resolution. In addition, the encoded clipping data is transmitted to the display apparatus 500 again.

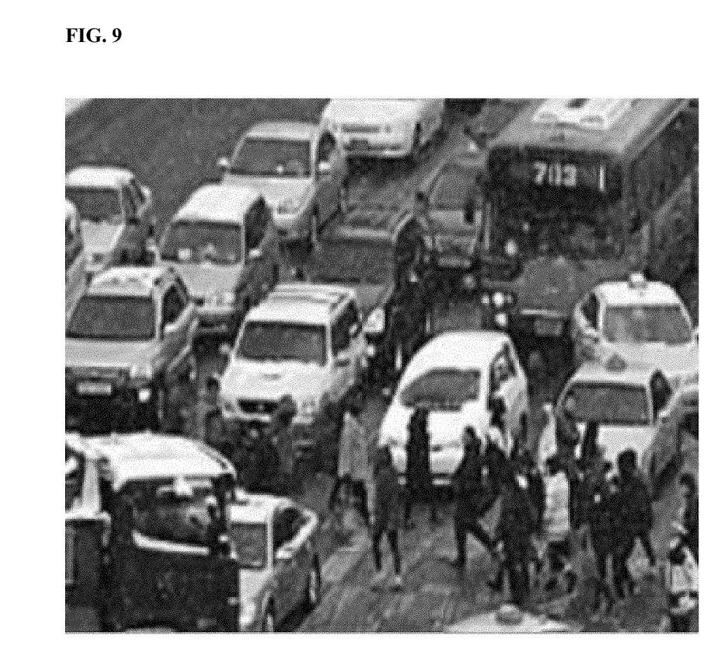

Then, since the display apparatus 500 displays only a clipped screen desired by the user as illustrated in FIG. 9, the network load may be reduced and spatial utilization in a limited monitor may be maximized.

Meanwhile, in the exemplary embodiment, map information displayed in the display apparatus 500 not only serves as a background but also serves to perform an active screen configuration in link with the received video data and reduce unnecessary data transmission.

In detail, when the user magnifies the electronic map at a predetermined ratio, the display controller 580 detects a range of the electronic map displayed in the monitor and compares the range of the electronic map displayed in the monitor and positional information of the plurality of camera units to detect the camera unit within the range of the electronic map displayed in the monitor. Said electronic map means not only real geographical images, but also object which includes positional information such as interior structure in a building or data structure diagram.

Further, the display controller 580 calculates the changed resolution according to a resolution change ratio corresponding to an electronic map change ratio and displays the screen with the existing output resolution in the temporarily changed screen size by transmitting a temporary video signal to the temporary video generating module 520. That is, as the screen configured by the temporary video generating module 520, a screen in which the resolution deteriorates as compared with the size of the screen is temporarily displayed. In this case, the screen displayed by the temporary video generating module 520 targets the camera unit within the range of the electronic map displayed in the monitor.

The change ratio of the electronic map and the screen resolution change ratio need not be the same as each other and it is preferable in terms of stability to make the screen resolution change ratio be lower than the change ratio of the electronic map.

Meanwhile, the display controller 580 transmits the unique identification number and the changed resolution request signal of the camera unit detected by the image processing server 300. The unique identification number may become information to identify the camera unit, such as the positional information of the camera unit, or the like.

When the video processing server 300 receives the changed resolution request signal, the image processing server 300 changes the resolution of the video data of the corresponding camera unit to the changed resolution and encodes the video data with the changed resolution. In addition, the video processing server 300 transmits the encoded video data to the display apparatus 500 again.

Then, the final video generating module 530 displays the screen temporarily displayed by the temporary video generating module with the changed resolution by using received video data newly transmitted with the changed resolution in the video processing server 300.

When the electronic map is reduced, the screen configuration by the temporary video generating module is omitted and another process is performed similarly to the contents.

When the user moves the electronic map displayed in the monitor, the display controller 580 detects the range of the electronic map displayed in the monitor and compares the range of the electronic map displayed in the monitor and the positional information of the plurality of camera units to detect the camera unit within the range of the electronic map displayed in the monitor.

The display apparatus 500 transmits the detected unique identification information of the camera unit to the video processing server 300 and the video processing server transmits encodes the detected video data of the camera unit and transmits the encoded video data to the display apparatus 500 again.

The present invention has been described with reference to the exemplary embodiments. However, it will be appreciated by those skilled in the art that various modifications and changes of the present invention can be made without departing from the spirit and the scope of the present invention which are defined in the appended claims.

What is claimed is:

1. A video processing system comprising:
a video processing server receiving video data from a plurality of camera units and changing a resolution of the video data and transmitting the video data with the changed resolution; and
a display apparatus configuring a screen based on the received video data received from the video processing server, receiving a screen conversion input from a user and requesting a change in resolution of the video data of a specific camera unit to the video processing server based on the screen conversion input.

2. The video processing system of claim 1, wherein the video processing server stores positional information of each camera unit and transmits the positional information to the display apparatus together with the video data, and
the display apparatus stores map information, and receives the positional information of the camera unit from the video processing server and displays the received video data at a corresponding camera position on a map.

3. The video processing system of claim 2, wherein the display apparatus displays the center of the screen of the corresponding camera unit to be positioned at the camera position and when a screen size is changed in one direction by a user, the display apparatus also similarly changes the screen size in another direction based on the center, and calculates a resolution which is in proportion to the changed screen size and transmits the calculated resolution to the video processing server.

4. The video processing system of claim 2, wherein the display apparatus displays map and received video data in a monitor and when the map is changed by the user, the display apparatus detects a range of an electronic map displayed in the map and compares the range of the electronic map displayed in the monitor and the positional information of the plurality of camera units to detect the camera unit within the range of the electronic map displayed in the monitor, and
the video processing server encodes the video data of the detected camera unit and transmits the encoded video data to the display apparatus again.

5. The video processing system of claim 1, wherein the display apparatus includes a clipping module, and when a clipping zone is set in the screen of the specific camera unit by the user, the clipping module calculates a clipping position in the screen of the camera unit and transmits the calculated clipping position and the resolution of the clipping zone to the video processing server, and
the video processing server converts clipping data corresponding to the clipping position from the video data of the camera unit into the resolution received from the display apparatus and transmits the resolution to the display apparatus.

6. A video processing method comprising:
receiving, by a video processing unit, video data from a plurality of camera units;
encoding, by the video processing unit, the video data and transmitting the encoded video data to a display apparatus;
displaying, by the display apparatus, the received video data received from the video processing unit;
calculating, by the display apparatus, a corresponding changed resolution and transmitting the calculated the changed resolution to the video processing unit when sensing that a screen size of the received vide data is changed by a user; and
changing, by the video processing unit, the resolution of the video data to the changed resolution and encoding the video data with the changed resolution and thereafter, transmitting the encoded video data to the display apparatus.
